(19) United States
(12) Patent Application Publication
(10) Pub. No.: US 2024/0400600 A1
(43) Pub. Date: Dec. 5, 2024

(54) RHEOLOGICALLY DEFINED LIGNIN COMPOSITIONS

(71) Applicant: SUZANO CANADA INC., Burnaby (CA)

(72) Inventors: John Frank Kadla, Vancouver (CA); Ray Ma, Vancouver (CA); James Ian Dallmeyer, Coquitlam (CA)

(21) Appl. No.: 18/802,299

(22) Filed: Aug. 13, 2024

Related U.S. Application Data
(63) Continuation-in-part of application No. 17/131,354, filed on Dec. 22, 2020, now abandoned.
Application No. 17/131,354 is a continuation of application No. PCT/CA2019/050883, filed on Jun. 26, 2019.
(60) Provisional application No. 62/690,245, filed on Jun. 26, 2018.

(51) Int. Cl. C07G 1/00

(52) U.S. Cl. CPC C07G 1/00

(57) ABSTRACT

Anthropogenic derivatives of native lignin are disclosed, having specific viscoelastic metrics which selectively facilitate the processing of these lignin derivatives into particular finished products. Such lignin derivatives are characterized by rheological metrics that include minimum storage modulus (G′ₘᵢₙ) and an extent of crosslinking.

### CROSS-REFERENCE TO RELATED APPLICATIONS

This application is a continuation-in-part of U.S. patent application Ser. No. 17/131,354, filed Dec. 22, 2020; which is a continuation of PCT/CA2019/050883, filed Jun. 26, 2019; which claims the benefit of U.S. Provisional Application No. 62/690,245, filed Jun. 26, 2018. The contents of the above-identified applications are incorporated herein by reference in their entirety.

### FIELD OF THE INVENTION

The invention relates to derivatives of native lignin derived from lignocellulosic feedstocks, and industrial applications thereof. More particularly, this invention relates to derivatives of native lignin having certain viscoelastic properties, as well as uses, processes, methods and compositions thereof.

### BACKGROUND OF THE INVENTION

Lignins are a heterogeneous class of complex cross-linked organic polymers. They form a relatively hydrophobic and aromatic phenylpropanoid complement to cellulose and hemicellulose in the structural components of vascular plants. Lignification is the final stage in plant cell wall development; lignin serving as the ‘adhesive’ consolidating the cell wall. As such native lignin has no universally defined structure. Native lignin is a complex macromolecule comprised of 3-primary monolignols (e.g. phenylpropane units; p-coumaryl alcohol, coniferyl alcohol and sinapyl alcohol) connected through a number of different carbon-carbon and carbon-oxygen linkages. The type of monolignol and inter-unit linkage vary depending on numerous factors including genetic and environmental factors, species, cell/growth type, and location within/between the cell wall.

Extracting lignin from lignocellulosic biomass generally results in lignin deconstruction/modification and generation of numerous lignin fragments of varying chemistry and macromolecular properties. Some processes used to remove lignin from biomass hydrolyse the lignin structure into lower molecular weight fragments with high amounts of phenolic hydroxyl groups thereby increasing their solubility in the processing liquor (e.g. sulphate lignins). Other processes not only deconstruct the lignin macromolecule, but also introduce new functional groups into the lignin structure to improve solubility and facilitate their removal (e.g. sulphite lignin). The generated lignin fragments are generally referred to as lignin derivatives and/or technical lignins. As it is quite difficult to elucidate and characterize such complex mixtures of molecules and macromolecules, lignin derivatives are usually described in terms of the lignocellulosic plant material used, and the methods by which they are produced and recovered from, i.e. lignin isolated from the Kraft pulping of a softwood species are referred to as softwood Kraft lignin. Likewise, the organosolv pulping of an annual fibre generates an annual fibre organosolv lignin, etc. (see for example U.S. Pat. Nos. 4,100,016; 7,465,791; and PCT Publication No. WO 2012/000093, A. L. Macfarlane, M. Mai et al., 20—Bio-based chemicals from biorefining: lignin conversion and utilisation, 2014).

Despite lignins being among the most abundant natural polymers on earth (A. L. Macfarlane, M. Mai et al., 20-Bio-based chemicals from biorefining: lignin conversion and utilisation, 2014), the large-scale commercial use of extracted lignin derivatives isolated from traditional pulping processes used in the manufacture of pulp for paper manufacturing has been limited. This is due not only to the important role lignins and lignin-containing processing liquors play in process chemical/energy recovery, but also due to the inherent inconsistencies in their chemical and physical properties. These inconsistencies can arise due to numerous factors, such as changes in biomass supply (region/time of year/climate) and the particular extraction/generation/recovery conditions employed, which are further complicated by the inherent complexities in the chemical/molecular structures of the biomass itself.

Notwithstanding their complexity, lignins continue to be evaluated for a variety of thermoplastic, thermoset, elastomer and carbonaceous materials. For example, softwood Kraft lignin has been shown to be an effective substitute component in many adhesive systems (phenol-formaldehyde, polyurethane and epoxy resins), rubber materials, polyolefins and carbon fibres (T. Q. Hu, Chemical Modification, Properties, and Usage of Lignin, 2002) (A. L. Macfarlane, M. Mai et al., 20-Bio-based chemicals from biorefining: lignin conversion and utilisation, 2014).

Thermal processing is a common step in the preparation of a variety of different types of polymeric materials, including lignin-based materials. For example, an advantage of thermosoftening plastics, i.e. thermoplastics, as a general class of materials is that they can form a viscous fluid-like state when heated, which then allows them to be repeatedly formed, molded, or extruded into a variety of shapes which are retained after the material is cooled. Examples of thermoplastics include classes of polyesters, polycarbonates, polylactates, polyvinyls, polystyrenes, polyamides, polyacetates, polyacrylates, and polyolefins such as polyethylenes and polypropylenes. Likewise, in thermoset plastic applications, specifically thermosetting resin systems, thermal processing is utilized to irreversibly cure the initial solid or viscous liquid polymer into an infusible, insoluble polymer network. Thermoset resins, which are usually malleable or liquid prior to curing, are often designed to be molded into their final shape, used as adhesives, or formed into fibrous materials such as carbon fibres. Examples of thermosets include classes of acrylic resins, polyesters and unsaturated vinyl esters, epoxies, polyurethanes, phenolic, amino and furan resins.

When designing/developing new multiphase materials or looking to replace one component material with another there are several key requirements: control of interfacial chemistry, microstructure, and reactivity (D. R. Paul and C. B. Bucknall, Polymer Blends: Formulation, 2000). In melt/thermal processing systems the viscoelastic behavior can indicate the morphology, processability and thus performance of multicomponent systems. As with synthetic polymer systems, the thermal properties of lignin have a strong influence on the resulting performance of lignin-based materials. These thermal properties can vary widely depending on the type of lignin, and may be characterized by a variety of techniques, which quantify different physical phenomena. Typically, glass transition temperature (T_{g}), softening temperature (Tₛ) and decomposition temperature (T_{d}) measurements have been used to describe and help predict lignin-based material processability and performance.

The glass transition temperature (T_{g}) is the most frequently cited parameter defining temperature at which amorphous polymers such as lignin transform from a rigid, glassy solid to a soft, rubbery material. At temperatures T<T_{g}, motion of lignin molecules is hindered by rigidity of the polymer backbone as well as intermolecular interactions between neighboring polymer chains, and the individual lignin molecules remain fixed with respect to one another. At T>T_{g} the thermal energy present in the system is sufficient to increase the flexibility of the polymer and disrupt the network of hydrogen bonds and other interactions holding lignin molecules in place. This means that at temperatures above T_{g}, molecular chains are able to move with respect to one another. The value of T_{g} is commonly measured with differential scanning calorimetry (DSC), which measures the amount of heat energy required to raise the temperature of a sample contained in a crucible relative to an identical empty crucible. The T_{g} is most typically assigned to the midpoint of a sigmoidal-shaped step change in the differential heat flow signal. For isolated lignins, a wide range of T_{g} values have been reported, typically in the range of 80-200° C. The value of T_{g} for isolated lignins is known to vary widely based on the specific biomass type, delignification process used for isolation, moisture content and the thermal history of the sample.

Due to their high carbon content, isolated lignins are candidate precursors for carbon materials such as activated carbons (AC) and carbon fibre (CF). Production of carbon materials requires thermal treatment of precursors at high temperature (often 1000° C. or higher) in inert conditions to eliminate non-carbon elements from their chemical structure. This thermal treatment is typically a series of steps designed in such a way as to optimize processing cost and final product performance; the details of a given thermal treatment process are optimized for a given type of carbon precursor. Due to the large degree of variability in thermal properties among isolated lignins, it is very difficult both to identify the ideal type of lignin for the production of a carbon material with specific properties, and to optimize the thermal processing steps leading to the best possible carbon product at the lowest possible cost. Various thermal analysis techniques are used to define important thermal characteristics of lignin, mainly T_{g}, as well as softening temperature, Tₛ, and decomposition temperature, T_{d}. Accurate characterization of lignin thermal properties can inform the conversion of lignin into high-performance products to improve process efficiency and final product performance.

A challenge in production of CF from isolated lignins is that there is a trade-off between the ability to form a fibre through spinning processes and the ability to maintain that fibre form during high temperature carbonization (i.e. the fibre must not melt and must retain its fibre shape and good mechanical properties). A stabilization step may be required after fibre spinning but prior to carbonization to convert fibre precursor to an infusible state capable of maintaining solid form during carbonization. This is most commonly achieved by heating the fibres in air to induce chemical crosslinks, similar to a resin curing (thermosetting) process. Unfortunately, most commercial/semi-commercial industrially produced lignins with good melt spinning performance, Alcell lignin for example, cannot be economically converted to CF because they require very slow heating rates (and thus long processing times) to achieve successful stabilization.

In the field of lignin-based CF processing, the value of T_{g} has been used as a benchmark to predict whether a given lignin will be able to undergo processing and produce a fibre with desirable properties (D. A. Baker and T. G. Rials, Recent advances in low-cost carbon fiber manufacture from lignin, 2013). For example, it has been reported that isolated lignins with T_{g}<130° C. are capable of forming filaments by melt spinning, but the time required for stabilization was on the order of days, too long to be economical. Thermal treatment of lignin prior to melt spinning has been used to increase the T_{g} and alter the melt flow properties of isolated lignin, and has the added benefit of increasing the yield after carbonization (on the basis of stabilized precursor fibre weight). Thermally treated lignin with higher T_{g} in the range of 135-145° C. was shown (D. A. Baker and T. G. Rials, Recent advances in low-cost carbon fiber manufacture from lignin, 2013) to maintain spinnability and required reduced stabilization time, but unfortunately as T_{g} was increased further, the melt processability of the lignin decreased and resulted in a lower quality fibre with reduced strength. When the T_{g} was increased above ˜160° C., the lignin was not melt spinnable, presumably due to a lack of thermal softening. It can be seen from published studies (D. A. Baker, F. S. Baker et al., Thermal Engineering of Lignin for Low-cost Production of Carbon Fiber, 2009, D. A. Baker and T. G. Rials, Recent advances in low-cost carbon fiber manufacture from lignin, 2013, I. Norberg, Y. Nordstrom et al., A new method for stabilizing softwood kraft lignin fibers for carbon fiber production, 2013, H. Mainka, O. Täger et al., Lignin—an alternative precursor for sustainable and cost-effective automotive carbon fiber, 2015) that when a lignin possesses thermal softening properties, it typically does not have sufficient reactivity to form the requisite chemical crosslinks in an economical amount of time. Researchers in the field have used the value of T_{g} to determine where on the spectrum of softening vs. crosslinkability a given lignin lies, and it is often assumed that the T_{g} is a good indicator of the expected softening and crosslinking behaviour for a given type of isolated lignin.

Other researchers have studied the thermal properties of lignin with more advanced analytical techniques that capture more information about lignin thermal softening and reactivity. A shortcoming of the use of T_{g} as a thermal metric for processability is that it conveys only limited information about the mechanical properties of lignin while it is undergoing heating. Rheological measurements are capable of filling this information gap, by allowing for measurements of the stiffness of lignin as a function of temperature and deformation. For example, steady shear rheometry with parallel plates has been used to show that solvent extracted Kraft lignin has much lower thermal reactivity than “crude” as-isolated Kraft lignin. This assessment was made on the basis of measurements conducted isothermally at selected temperatures under continuous shear deformation, which showed that the apparent molten viscosity of “crude” Kraft lignin increased as a function of time while solvent-extracted lignin maintained a constant apparent shear viscosity with time. Similar to observations with Alcell lignin, this solvent extracted Kraft lignin was shown to have excellent melt spinning performance, but stabilization required very slow heating rates to avoid melting, due to low thermal reactivity (D. A. Baker, N. C. Gallego et al., On the characterization and spinning of an organic-purified lignin toward the manufacture of low-cost carbon fiber, 2012).

Another variation of rheometry uses dynamic oscillation over a small strain amplitude to measure the viscoelastic properties as a function of temperature and deformation. The advantage of dynamic oscillation is that the viscoelastic response of a material can be expressed in a decomposed form that provides information about the relative magnitudes of elastic and viscous contributions to the overall stress response to deformation. For example, small amplitude oscillatory shear (SAOS) rheometry has been used to study the evolution of viscoelastic properties during pyrolysis of biomass and its components, including lignin, and has also been used to study the carbonization of coals. This type of data has been used to identify the onset and extent of softening, and onset and extent of solidification and their associated temperature ranges under heating rates in the range of 1-5° C./min. Interestingly, the SAOS rheometry technique can distinguish between lignins that soften and those that do not, but more powerfully, the technique can provide a measurement of the magnitude of softening or crosslinking as function of temperature and heating rate, which is not possible based solely on measurements of T_{g} with differential scanning calorimetry. The SAOS technique is also notable for its ability to unambiguously define the temperature ranges associated with softening and crosslinking.

### SUMMARY OF THE INVENTION

Anthropogenic derivatives of native lignin are provided, having specific viscoelastic metrics, which selectively facilitate the processing of these lignin derivatives into particular finished products. Such lignin derivatives are characterized by rheological metrics that may, for example, include minimum storage modulus (G′ₘᵢₙ), onset of softening temperature (T₁), and/or cross-over temperature (T₂) from predominately viscous to predominately elastic behaviour.

Select embodiments include lignin derivatives prepared for use in thermoprocessing, for example being characterized as having a G′ₘᵢₙ of less than or equal to 10,000 Pa, a T₁ greater than or equal to 125° C., a T₂ greater than or equal to 175° C., and an extent of crosslinking (ΔG′₂=G′₂₅₀/G′ₘᵢₙ) such that an increase in storage modulus (ΔG'₂) from G′ₘᵢₙ to that measured at 250° C. (G′250) is less than about 4 or more than about 7. Embodiments of this kind may, for example, be particularly suited for use in methods of forming molded or extruded thermoplastic forms.

Alternative embodiments include lignin derivatives prepared for use in forming fibres, films, sheets, coatings, particles or nanoparticles, for example, being characterized as having a G′ₘᵢₙ of greater than or equal to 100,000 Pa, a T₁ greater than or equal to 170° C. and a T₂ greater than or equal to 250° C. Embodiments of this kind may, for example, be particularly suited for use in methods of producing a fibrous material, such as carbon fibres.

Further embodiments include lignin derivatives prepared for use in forming fibres, films, sheets, coatings, particles and nanoparticles, wherein said lignin derivative is characterized as having a minimum storage modulus (G′ₘᵢₙ) of greater than or equal to 100,000Pa, and a tan (δ) of less than 1.

Also described herein are methods of forming a molded or extruded thermoplastic form having a shape, comprising heating a lignin derivative as described herein above T₁, to form a heated thermoplastic material that is in a predominantly viscous state and has a storage modulus of less than or equal to 10,000 Pa; forming the heated thermoplastic material into the shape of the thermoplastic form; and cooling the heated thermoplastic material below T₁ to provide the thermoplastic form.

Also described herein are methods of thermo-forming a composite material comprising binding a plurality of parts composed of solid material into a solid composite form, wherein the parts are joined by heating and compression in an admixture with an adhesive comprising a lignin derivative as described herein, wherein the heating and compression raise the admixture to a temperature above T₁.

Also described herein are methods of forming a molded or extruded thermoset form having a shape, comprising: heating a lignin derivative as described herein above T₁, to form a heated material, so that the heated material is in a predominantly viscous state and has a storage modulus of less than or equal to 10,000 Pa; forming the heated material into the shape of the thermoset form, to form a shaped thermoset form; heating the shaped thermoset form beyond T₂; holding the shaped thermoset form at T₂ for more than 1 minute; and cooling the shaped thermoset form below T₁ to provide the molded or extruded thermoset form.

Also described herein are methods of solution forming a composite material comprising a plurality of parts composed of solid material into a solid composite form, wherein the parts are consolidated by a heating and/or compression as an admixture comprising a lignin derivative as described herein, wherein the heating and/or compression raise the admixture to a temperature above T₂, or to a temperature above temperature at G′ₘᵢₙ.

Also described herein are methods of solution forming a composite material comprising a plurality of parts composed of solid material into a compression as an admixture comprising a lignin derivative as described herein, wherein the heating and/or compression raise the admixture to a temperature above T₁.

Also described herein are methods of forming a fibrous material comprising the steps of: dissolving a lignin derivative as described herein in a fibre spinning solvent, to produce a dissolved lignin; and spinning the dissolved lignin into a fibrous form.

Also described herein are methods of producing the lignin derivatives as described herein, comprising separating lignin from cellulosic material and testing the lignin to measure one or more rheological characteristics comprising G′ₘᵢₙ, T₁ and T₂.

Also described herein are methods of solution forming a material comprising the steps of: dissolving a lignin derivative as described herein in a solvent, to produce a dissolved lignin; and casting the dissolved lignin into a shape or form of the material. In various embodiments, the shape or form may be a fibre, a film, a sheet, a coating, a particle, a nanoparticle or the like.

In various aspects, described herein are anthropogenic lignin derivatives having a minimum storage modulus (G′ₘᵢₙ) of less than or equal to 10,000 Pa, and an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is less than about 4 or more than about 7, wherein the lignin derivative is derived from hardwood biomass or from a combination of hardwood biomass and softwood biomass with at least 75% hardwood biomass, and is produced by pulping of lignocellulosics by Kraft pulping or ethanol/solvent pulping. In various embodiments, the lignin derivative has a G′ₘᵢₙ of about 8,000 Pa or less, about 5,000 or less, about 1,000 Pa or less, or about 100 Pa or less. In various embodiments, the lignin derivative has an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is about 7 or greater, about 8 or greater, or about 10 or greater. In various embodiments, the lignin derivative has an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is about 3 or less. In various embodiments, the lignin derivative has an onset of softening temperature (T₁) greater than or equal to 110° C., greater than or equal to 125° C., or greater than or equal to 150° C. In various embodiments, the lignin derivative has a cross-over temperature (T₂) from predominantly viscous to predominantly elastic behaviour of greater than or equal to 165° C., greater than or equal to 175° C., or greater than or equal to 220° C. In various embodiments, the lignin derivative is derived from hardwood biomass. In various embodiments, the lignin derivative is produced by pulping of lignocellulosics by Kraft pulping.

In various aspects, described herein are methods of forming a molded or extruded thermoplastic form having a shape, comprising: heating the lignin derivative as described above to a temperature about T₁, to form a heated thermoplastic material that is in a predominantly viscous state and has a storage modulus of less than or equal to 10,000 Pa; forming the heated thermoplastic material into the shape of the thermoplastic form; and cooling the heated thermoplastic material below T₁ to provide the thermoplastic form. In various embodiments, the lignin derivative is mixed with one or more thermoplastic polymer. In various embodiments, the lignin derivative and the thermoplastic polymer are coextruded to form a freestanding, self-supporting composite form. In various embodiments, the composite form is a multilayer film or a composite fibre. In various embodiments, the thermoplastic polymer comprises a condensation polymer. In various embodiments, the thermoplastic polymer comprises an alkyd. In various embodiments, the thermoplastic polymer comprises a polymer resin, modified polymer alloy and/or filled polymer blend. In various embodiments, the thermoplastic polymer is advanceable by solid state polymerization.

In various aspects, described herein are methods of thermos-forming a composite material comprising binding a plurality of parts composed of solid material into a solid composite form, wherein the parts are joined by heating and compression in an admixture with an adhesive comprising the lignin derivative as described above, wherein the heating and compression raise the admixture to a temperature about T₁. In various embodiments, the solid composite form is an engineered wood product.

In various aspects, described herein are methods of forming a molded or extruded thermoset form having a shape, comprising: heating the lignin derivative as described above T₁, to form a heated material, so that the heated material is in a predominantly viscous state and has a storage modulus of less than or equal to 10,000 Pa; forming the heated material into the shape of the thermoset form, to form a shaped thermoset form; heating the shaped thermoset form beyond T₂; holding the shaped thermoset form at T₂ for more than 1 minute; and cooling the shaped thermoset form below T₁ to provide the molded or extruded thermoset form. In various embodiments, the lignin derivative is mixed with one or more thermoplastic polymers. In various embodiments, the lignin derivative and the thermoplastic polymer are coextruded to form a freestanding, self-supporting composite form. In various embodiments, the composite form is a multilayer film or a composite fibre. In various embodiments, the thermoplastic polymer comprises a thermoset polymer.

In various aspects, described herein are methods of solution forming a composite material comprising a plurality of parts composed of solid material into a solid composite form, wherein the parts are consolidated by a heating and/or compression as an admixture comprising the lignin derivative as described above, wherein the heating and/or compression raise the admixture to a temperature above T₂, or to a temperature above the temperature at G′ₘᵢₙ. In various embodiments, the lignin derivative is mixed with one or more thermoplastic polymers. In various embodiments, the thermoplastic polymer comprises polyacrylonitrile and/or associated copolymers. In various embodiments the thermoplastic polymer comprises a condensation polymer. In various embodiments, the thermoplastic polymer comprises an alkyd. In various embodiments, the thermoplastic polymer comprises a polymer resin, modified polymer alloy or filled polymer blend. In various embodiments, the thermoplastic polymer is advanceable by solid state polymerization. In various embodiments, the lignin derivative is mixed with one or more thermosetting polymers and/or one or more thermosetting resins. In various embodiments, the one or more thermosetting polymers and/or the one or more thermosetting resins comprise a polyester resin, a polyurethane, a phenol-formaldehyde, a urea-formaldehyde, a melamine resin, an epoxy resin or a combination thereof. In various embodiments, the thermosetting polymer comprises an elastomer. In various embodiments, the solid composite form is an engineered wood product. In various embodiments, the engineered wood product is a plywood, fibre board, MDF, HDF, oriented strand board or particle board.

In various aspects, described herein are anthropogenic lignin derivatives for use in forming fibres, films, sheets, coatings, particles and nanoparticles, wherein said lignin derivatives are characterized as having a minimum storage modulus (G′ₘᵢₙ) of greater than or equal to 100,000 Pa and a tan(δ) of less than 1. In various embodiments, the lignin derivative has a G′ₘᵢₙ of about 200,000 Pa or greater. In various embodiments, the lignin derivative is derived from hardwood biomass. In various embodiments, the lignin derivative is produced by pulping of lignocellulosics by Kraft pulping. In various embodiments, the lignin derivative is subject to a thermal treatment at a temperature greater than about 150° C. after pulping.

In various aspects, described herein are methods of producing a fibrous material comprising the steps of: dissolving the lignin derivative as described above in a fibre spinning solvent, to produce a dissolved lignin; and spinning the dissolved lignin into a fibrous form. In various embodiments, the fibre spinning solvent comprises one or more co-solvents, fibre forming polymers, fibre forming additives, fibre forming fillers, fibre forming catalysts or thermal stability modifiers. In various embodiments, the fibre spinning process is electrospinning, wet spinning, dry spinning, dry-jet wet spinning, solution blowing or centrifugal spinning. In various embodiments, the step of spinning the dissolved lignin into the fibrous form comprises producing a fibrous carbon material comprising the steps of: thermally stabilizing the fibrous form in an oxidizing atmosphere while heating to 250° C. at a heating rate greater than 3° C./min, to provide fibres; and carbonizing the fibres at temperatures greater than 450° C. to provide the fibrous carbon material.

In various aspects, described herein are methods of solution forming a material comprising the steps of: dissolving the lignin derivatives as described above in a solvent, to produce a dissolved lignin; and casting the dissolved lignin into a shape or form of the material. In various embodiments, the solvent comprises one or more co-solvents, fibre forming polymers, fibre forming additives, fibre forming fillers, fibre forming catalysts or thermal stability modifiers.

### BRIEF DESCRIPTION OF THE DRAWINGS

FIG. 1: Temperature ramp of a derivative of native lignin showing the changes in viscoelastic moduli, G′ and G″, and their ratio (G″/G′=tan(δ)) as a function of temperature while a small amplitude sinusoidal strain is applied to the sample. Also included are magnified views of points <T₁>, <T₂>, <G′ₘᵢₙ>, <ΔG′₂> shown in the corresponding black boxes. The derivative of native lignin was derived from hardwood biomass (Eucalyptus) and produced by pulping of lignocellulosics by ethanol/solvent pulping (organosolv).

FIG. 2: Weight loss as a function of temperature for a derivative of native lignin. The derivative of native lignin was derived from hardwood biomass (Eucalyptus) and produced by pulping of lignocellulosics by Kraft pulping.

FIG. 3: Storage modulus vs temperature for derivatives of native lignin Illustrating the impact of the specific rheological metrics on processability into carbon fibres. Lignin 1 (bottom curve) is a lignin derivative derived from hardwood (Eucaplytus) and produced by pulping of lignocellulosics by ethanol/solvent pulping (Organosolv), Lignin 2 (top curve) is a lignin derivative derived from softwood (North America) and produced by pulping of lignocellulosics by Kraft pulping, and Lignin 3 (middle curve) is a lignin derivative derived from hardwood (Eucalyptus) and produced by pulping of lignocellulosics by Kraft pulping.

FIG. 4: Effect of blending different lignins on the resulting blend viscoelastic metrics. Lignin 1 is a lignin derivative derived from hardwood (North America) and produced by pulping of lignocellulosics by ethanol/solvent pulping (organosolv) and Lignin 2 is a lignin derivative derived from softwood (North America) and produced by pulping of lignocellulosics by Kraft pulping.

### DETAILED DESCRIPTION OF THE INVENTION

The present invention provides derivatives of native lignin having certain viscoelastic metrics. Lignin derivatives having specific combinations of onset of softening (T₁), minimum storage modulus (G′ₘᵢₙ), cross-over temperature from predominately viscous to predominately elastic behaviour (T₂) and extent of crosslinking (ΔG′₂) have been found to process more effective in industrially relevant applications. Thus, selecting for derivatives of native lignin having specific viscoelastic metrics results in a product having a higher and more predictable processing and materials performance.

It has been found that derivatives of native lignin having a minimum storage modulus (G′ₘᵢₙ) of less than or equal to 10,000 Pa and an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is less than about 4 or more than about 7, wherein the lignin derivative is derived from hardwood biomass or from a combination of hardwood biomass and softwood biomass with at least 75% hardwood biomass, and is produced by pulping of lignocellulosics by Kraft pulping or ethanol/solvent pulping, result in good thermosoftening materials. For example, a G′ₘᵢₙ about 8,000 Pa or less, about 5,000 Pa or less, about 1,000 Pa or less, or about 100 or less.

It has also been found that derivatives of native lignin having a minimum storage modulus (G′ₘᵢₙ) of less than or equal to 10,000 Pa, along with an onset of softening temperature (T₁) greater than or equal to 125° C. and a cross-over temperature (T₂) from predominately viscous to predominately elastic behaviour of greater than or equal to 175° C. result in good thermosoftening materials. For example, a G′ₘᵢₙ about 8,000 Pa or less, about 5,000 Pa or less, or about 1,000 Pa or less, or about 100 Pa or less, a T₁ about 130° C. or greater, about 150° C. or greater, about 170° C. or greater, and a T₂ of about 180° C. or greater, about 200° C. or greater, or about 220° C. or greater.

Furthermore, said derivatives of native lignin also having a high extent of crosslinking (ΔG′₂=G′₂₅₀/G′ₘᵢₙ), i.e. an increase in storage modulus (ΔG′₂) from G′ₘᵢₙ to that measured at 250° C. (G′₂₅₀) is more than 600% (ΔG′2>7) results in plastic materials with a good combination of thermosoftening and thermosetting properties (e.g. melt/fusion fibre spinning, thermosetting resins, etc.). For example, a ΔG′₂ about 7 or greater, about 8 or greater, about 9 or greater, about 10 or greater, or about 100 or greater. In other embodiments, a ΔG′₂ of about 4 or less, about 3 or less, about 2 or less, or about 1 or less also results in plastic materials with a good combination of thermosoftening and thermosetting properties.

Similarly, derivatives of native lignin having a minimum storage modulus (G′ₘᵢₙ) of greater than or equal to 100,000 Pa, along with an onset of softening temperature (T₁) greater than or equal to 170° C. and a cross-over temperature (T₂) from predominately viscous to predominately elastic of greater than or equal to 250° C. result in good fibre forming materials (e.g. carbon fibres) via solution spinning (e.g. wet-, dry-, gel-, electrospinning, and the like). For example, a G′ₘᵢₙ about 200,000 Pa or greater, about 500,000 Pa or greater, or about 1,000,000 Pa or greater, a T₁ about 175° C. or greater, about 200° C. or greater, about 225° C. or greater, or about 245° C. or greater, and a T₂ of about 260° C. or greater, about 280° C. or greater, or about 300° C. or greater.

The present invention provides derivatives of native lignin recovered during or after pulping of lignocellulosic feedstocks. The pulp and/or lignin and/or derivative thereof may be from any suitable lignocellulosic feedstock including hardwoods, softwoods, annual fibres, and combinations thereof. For example, the pulp and/or lignin and/or derivative thereof may be from a hardwood. For example, the pulp and/or lignin and/or derivative thereof may be from a combination of hardwood and softwood. The combination of hardwood and softwood may comprise at least 75% hardwood and a maximum of 25% softwood.

It has been found that derivatives of native lignin from hardwood feedstocks having G′ₘᵢₙ of less than or equal to 10,000 Pa and ΔG′₂ of about 7 or greater, about 8 or greater, about 10 or greater have good fibre melt/fusion spinning and thermal processing (e.g. stabilization kinetics) into carbon materials. It has also been found that derivatives of native lignin, for example from hardwood, softwood or annual fibre feedstocks, having G′ₘᵢₙ of less than or equal to 10,000 Pa, T₁ greater than or equal to 125° C. and ΔG′₂ of more than 7 have good fibre melt/fusion spinning and thermal processing (e.g. stabilization kinetics) into carbon materials. For example, G′ₘᵢₙ about 5,000 Pa or less, 1,000 Pa or less, about 100 Pa or less, T₁ about 130° C. or greater, about 150° C. or greater, about 170° C. or greater, a ΔG′₂ about 7 or greater, about 8 or greater, about 10 or greater, or about 100 or greater. In other embodiments, a ΔG′₂ of about 4 or less, about 3 or less, about 2 or less, or about 1 or less also results in lignin derivatives with good fibre met/fusion spinning and thermal processing into carbon materials.

It has been found that derivatives of native lignin, for example from hardwood, softwood or annual fibre feedstocks, having a G′ₘᵢₙ of greater than or equal to 200,000 Pa, T₁ greater than or equal to 170° C. and T₂ greater than or equal to 250° C. have good fibre solution spinning and thermal processing into carbon materials. For example, G′ₘᵢₙ about 250,000 Pa or greater, 500,000 Pa or greater, about 1,000,000 Pa or greater, T₁ about 175° C. or greater, about 180° C. or greater, about 200° C. or greater, a T2 about 260° C. or greater, about 280° C. or greater, or about 300° C. or greater.

In the present invention, “onset of softening”, “minimum storage modulus”, “cross-over temperature [from predominately viscous to predominately elastic behaviour]” and “extent of crosslinking” refer to the viscoelastic behaviour or “metrics” of the lignin derivatives. These viscoelastic metrics can be measured by small amplitude oscillatory shear (SAOS) rheometry (also known as dynamic mechanical thermal analysis or DTMA) using, for example, a TA Instruments DHR rheometer. Various sample forms can be utilized including powders, pressed disks, sheets, fibres and other woven/nonwovens and analyzed under oxidative and/or inert atmospheres. In a typical experiment a lignin derivative is placed between two parallel circular plates, a sinusoidally varying strain, γ(t)=γ₀sin(ωt) is applied and the sample is heated through a specific temperature range while the mechanical response is measured.

In select embodiments, the signal quality and consistency of the measurements may be better at low temperatures (prior to any thermal softening that may occur) when compressed samples are used. Compressed samples are typically less affected by frictional dissipative losses, but are known to also possess dissipative losses, and thus moduli reported therefrom are reported as apparent values.

In some embodiments, a consistent low temperature modulus measurement may be helpful to facilitate the proper execution of the temperature ramp program by the rheometer, where the sample is typically held under a small positive axial compressive force to prevent slipping at low temperature. The program may also be designed to reduce the axial compression at a set modulus value prior to the occurrence of significant thermal softening, to prevent the more fluid-like sample from being squeezed out from between the plates.

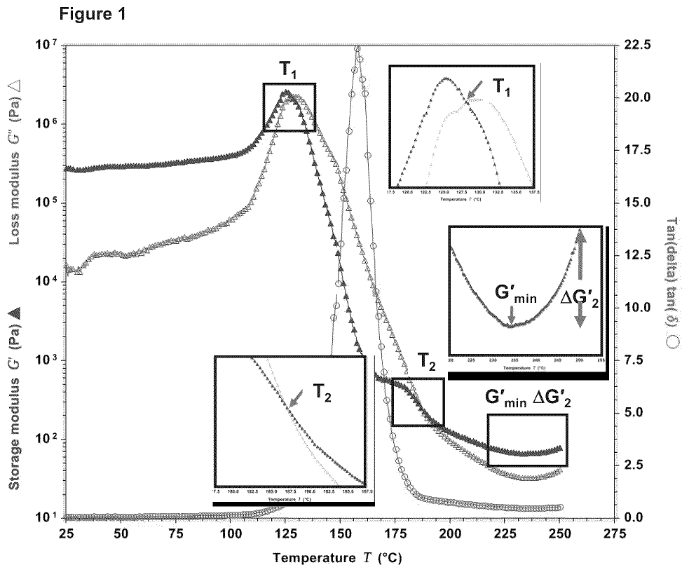

The modulus corresponding to the stress component that is in phase with the strain wave is commonly referred to as the storage modulus, is equal to τ₀′/γ₀, and is typically denoted G′. The modulus corresponding to the stress component that is 90° out of phase with the strain wave (in phase with the rate of strain wave) is commonly referred to as the loss modulus, is equal to τ₀″/γ₀, and is typically denoted G″. In the present examples, the frequency ω is held constant at 1 Hz (6.2 rad/s) and γ₀ held within a limit so as to ensure that the measurements are made within the limits of the linear viscoelastic region of the material. As illustrated herein (FIG. 1), the small strain viscoelastic moduli G′ and G″ provide valuable information about the viscoelastic behaviour of lignin as a function of temperature and time. In addition, in some embodiments, it is useful to define the ratio G″/G′=tan(δ) to describe the relative magnitude of the viscous and elastic contributions to the measured shear stress. While the sinusoidal strain is being applied to the lignin sample, it can be heated at controlled rates up to 5° C./min (a practical upper limit to avoid lag between actual temperature of the sample and set temperature) and the value of G′ and G″ can be measured as a function of temperature at different heating rates. While the present viscoelastic metrics relate to samples heated at a rate of 3° C./min, slower or faster heating rates can be used to reveal the relative thermoplasticity and reactivity, i.e. softening and crosslinking behaviour, of lignins and derivatives of lignin.

Anthropogenic derivatives of native lignin can, for example, be obtained by (1) solvent extraction of finely ground wood (milled wood lignin, MWL) or by (2) acidic dioxane extraction (acidolysis) of wood. Derivatives of native lignin can be also isolated from biomass pre-treated using (3) steam explosion, (4) dilute acid hydrolysis, (5) ammonia fibre expansion, (6) autohydrolysis methods. Derivatives of native lignin can be recovered after pulping of lignocellulosics including industrially operated (3) Kraft and (4) soda pulping (and their modifications) and (5) sulphite pulping. In addition, a number of various pulping methods have been developed but not industrially introduced, among them are (1) ethanol/solvent pulping (aka the Alcell® process or organosolv), (2) alkaline sulphite anthraquinone methanol pulping (aka the “ASAM” process), (3) methanol pulping followed by methanol, NaOH, and anthraquinone pulping (aka the “Organocell” process), (4) acetic acid/hydrochloric acid or formic acid pulping (aka the “Acetosolv” process) and (5) high-boiling solvent pulping (aka “HBS” pulping). In various embodiments, the anthropogenic derivatives of native lignin are recovered after pulping of lignocellulosics by Kraft pulping (and its modifications) and by ethanol/solvent pulping (organosolv).

Prior to or following extraction, isolation and/or pulping, the anthropogenic derivatives of native lignin may be separated into discrete fractions by one or more than one refining techniques. These refining techniques include, for example, filtration (such as, for example, nano-, micro- or ultra-filtration), extraction (such as, for example, liquid-liquid extraction or liquid-solid extraction), thermal treatment (such as, for example, atmospheric or under reduced pressure) and the like. In various embodiments, prior to or following extraction, isolation and/or pulping, the anthropogenic derivatives of native lignin are separated into discrete fractions by extraction and/or thermal treatment. In other embodiments, the anthropogenic derivatives of native lignin are not separated into discrete fractions by refining techniques prior to or following extraction, isolation or pulping.

The derivatives of native lignin herein may be utilized alone or may be incorporated into polymer compositions. The compositions disclosed herein may comprise a derivative of native lignin according to the present invention and a polymer-forming component. As used herein, the term ‘polymer-forming component’ means a component that is capable of being polymerized into a polymer as well as a polymer that has already been formed. For example, in certain embodiments the polymer-forming component may comprise monomer units which are capable of being polymerized. In certain embodiments, the polymer component may comprise oligomer units that are capable of being polymerized. In certain embodiments, the polymer component may comprise a polymer that is already substantially polymerized.

Polymer forming components for use herein may result in thermoplastic or thermoset polymers and copolymers such as epoxy resins, urea-formaldehyde resins, phenol-formaldehyde resins, polyimides, polyacrylates, polynitriles, isocyanate resins, and the like. For example, polyolefins such as polyethylene or polypropylene and polynitriles like polyacrylonitrile copolymers.

Typically, the derivative of native lignin will comprise from about 0.1%, by weight, or greater, about 0.5%, by weight, or greater, about 1%, by weight, or greater, of the composition. Typically, the lignin derivative will comprise from about 99.9%, by weight, or less, about 80%, by weight, or less, about 60%, by weight, or less, about 40%, by weight, or less, about 20%, by weight, or less, about 10%, by weight, or less of the composition.

The compositions comprise a derivative of native lignin and polymer-forming component, but may comprise a variety of other optional ingredients such as adhesion promoters; biocides (antibacterials, fungicides, and moldicides), anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; foaming agents; defoamers; hardeners; odorants; deodorants; antifouling agents; viscosity regulators; waxes; and combinations thereof.

The present invention provides the use of the present derivatives of native lignin as a functional component in thermoplastics, thermosets, and fibre forming polymers, alone or in combination with traditional or evolving polymers. For example, the present use may be to impart enhanced thermal stability and mechanical performance with thermoplastic polymers such as polyethylenes, polypropylenes, polyamides, polynitriles, styrene-butadiene, and combinations thereof. Other examples include: increased curing of butyl rubbers, improved abrasion index in synthetic (polybutadiene, nitrile, neoprene, styrene-butadiene) and natural rubbers; improved yield and thermal processing of polyacrylonitrile copolymer into carbon fibres; enhanced mechanical properties, gluability, and reduced emissions (e.g. formaldehyde) in adhesive sealants, epoxy resins and phenolic-formaldehyde resins.

### EXAMPLES

### Example 1: The Temperature Ramp Curve of a Lignin Sample

A typical curve for a lignin sample heated at 3° C./min under nitrogen gas flow (in the absence of oxygen) is shown in FIG. 1. The lignin sample is a derivative of native lignin derived from hardwood biomass (Eucalyptus) and produced by pulping of lignocellulosics by ethanol/solvent pulping (organosolv). The general shape of the curves in FIG. 1 are indicative of a significant degree of softening occurring roughly between 125-225° C. At low temperature, the storage modulus (G′) is roughly 1 order of magnitude larger than the loss modulus (G″), indicating that the lignin pellet displays predominantly elastic or solid-like mechanical behaviour (as expected, since the analysis temperature is far below T_{g}). Just prior to softening, both moduli show an increase up to a peak value, which can be attributed to compaction/densification of the sample as it is heated above its glass transition temperature, leading to increased overall resistance to deformation. After reaching their peak values, both G′ and G″ decrease by roughly 4 orders of magnitude as temperature is raised from 125 to 225° C., this decrease in moduli corresponds to thermal softening.

An aspect of this example involves the definition and determination of select points along a temperature ramp curve in a rheological characterization of lignin. In one aspect of the invention, there are three alternative points of rheological characteristics that may be used to classify lignin, which are indicated with black boxes in FIG. 1, and further illustrated in the associated magnified images.

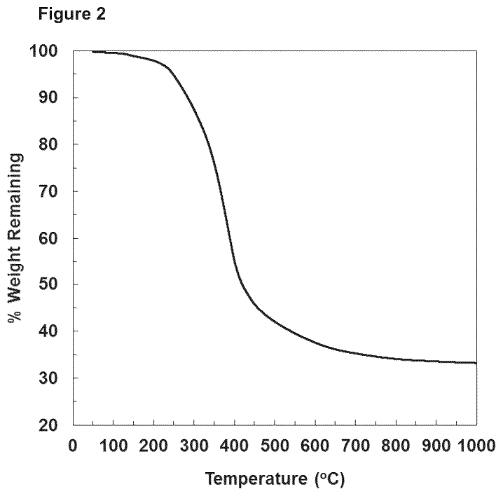

The point <T₁> represents the temperature (T=T₁) at the first point of cross-over where G′=G″ and beyond which G′<G″. In this Example, the apparent viscoelastic moduli G′ and G″ are around 106 Pa. Beyond this point the material still displays significant resistance to deformation, but this resistance drops off rapidly as temperature is increased and the viscous contribution to the shear stress is larger than the elastic contribution. The value of temperature at the point T₁ will be referred to as the softening onset temperature. Likewise, the second cross-over is denoted T₂ and represents the temperature where G′=G″ again and beyond which G″<G′ once more. This point indicates a transition from predominantly viscous liquid behaviour back to predominantly elastic behaviour, and is represented by the cross-over temperature T₂. Beyond this point as temperature is increased further both moduli continue to decrease until point G′ₘᵢₙ, where a local minimum is reached. At this point we have reached the softest state that this lignin sample will enter, and define the minimum storage modulus G′ₘᵢₙ. It should be noted here that not all lignin samples display a local minimum in storage modulus below the onset of thermal decomposition, so in these cases the extent of softening would be determined based on the change in storage modulus between the onset of softening at T₁ and the modulus at a temperature of thermal degradation onset, which for most lignin's is approximately around 250° C. A graph of % weight loss as a function of temperature at a heating rate of 10° C./min is shown in the FIG. 2 for atypical Kraft lignin derived from hardwood (Eucalyptus) biomass.

For the lignin sample shown in FIG. 1 it can be seen that G′ starts to increase between G′ₘᵢₙ and 250° C., indicating the onset of thermally induced crosslinking; another phenomenon that is of interest for the production of lignin-based materials through thermal processing routes. This temperature may also be a convenient endpoint for evaluation of thermal softening and low temperature cross-linking, as 250° C. is a typical temperature to conduct oxidative thermostabilization of lignin fibres to prepare them for production of carbon fibres, and can be considered a practical upper limit for processing of some commodity thermoplastics. Therefore, we define the extent of crosslinking (ΔG′₂) as the change in modulus occurring between G′ₘᵢₙ and that at 250° C. (ΔG′₂=G′₂₅₀/G′ₘᵢₙ).

### Example 2: Rheological Comparison of Different Lignins and Corresponding Thermal Processability

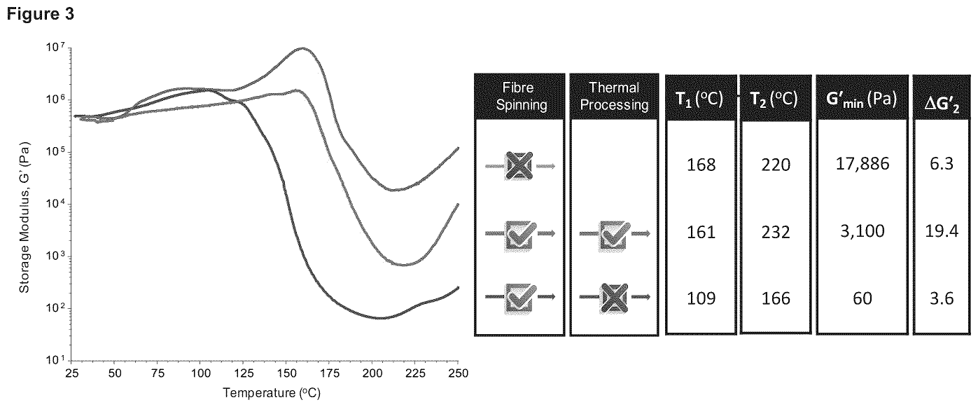

FIG. 3 shows the rheological fingerprint of three lignins measured in an air atmosphere using 25 mm lignin pellets. Lignin 1 (bottom curve; lignin derivative derived from hardwood (Eucalyptus) and produced by pulping of lignocellulosics by ethanol/solvent pulping (Organosolv)) exhibits a high degree of thermal softening with a small G′ₘᵢₙ (<100 Pa) and a relatively low extent of crosslinking, ΔG′₂=3.6. Lignin 2 (top curve; lignin derivative derived from softwood (North America) and produced by pulping of lignocellulosics by Kraft pulping) exhibits a low degree of thermal softening (G′min >10,000 Pa) and a moderate extent of crosslinking, ΔG′_{2=6.3}. Lignin 3 (middle curve; lignin derivative derived from hardwood (Eucalyptus) and produced by pulping of lignocellulosics by Kraft pulping) exhibits a moderate degree of thermal softening (G′ₘᵢₙ>1,000 Pa) and a high extent of crosslinking, ΔG′2=19.4. Lignin 1 and 3 are readily processed thermally, e.g. thermo-formed or melt-spun into a variety of forms, including fibres, while Lignin 2 does not sufficiently soften to enable thermal spinning into a fibre form. By the same token, Lignin 1 cannot be converted into carbon fibre at commercially relevant processing rates, requiring very slow thermostabilization heating rates of <1° C./min. Lignin 3 on the other hand can be readily spun into fibres and thermostabilizes at heating rates well in excess of 5-10° C./min.

Table 1 illustrates the effect of lignin viscoelastic metrics on solution forming and subsequent thermal processing. Lignin 4 and Lignin 5 were both lignin derivatives derived from hardwood (Eucalyptus) and produced by pulping of lignocellulosics by Kraft pulping. Following pulping, Lignin 4 was subject to a low temperature thermal treatment (such as, for example, drying at less than 150° C. and Lignin 5 was subject to a higher temperature thermal treatment (such as, for example, drying at greater than 150° C.). Lignin 4 exhibits a low degree of thermal softening with a G′ₘᵢₙ<100,000 Pa and is a moderately viscous material with a tan(δ)>1. Lignin 5 exhibits very little softening with G′ₘᵢₙ>100,000 Pa and tan (δ)<1, indicative of predominately elastic behaviour. Lignin 4 requires significantly lower thermal processing rates than that of Lignin 5, which can be thermally processed at heating rates greater than 20° C./min.

TABLE 1
Effect of lignin viscoelastic metrics on solution
forming and subsequent thermal processing

| | | G′ₘᵢₙ | Heating Rate |
|---|---|---|---|
| Sample | Tan(δ) | (Pa) | (° C./min) |
| Lignin 4 | 3.9 | 12,831 | <3 |
| Lignin 5 | 0.65 | 257,798 | >>20 |

### Example 3: Effect of Lignin Blending to Manipulate Viscoelastic Metrics

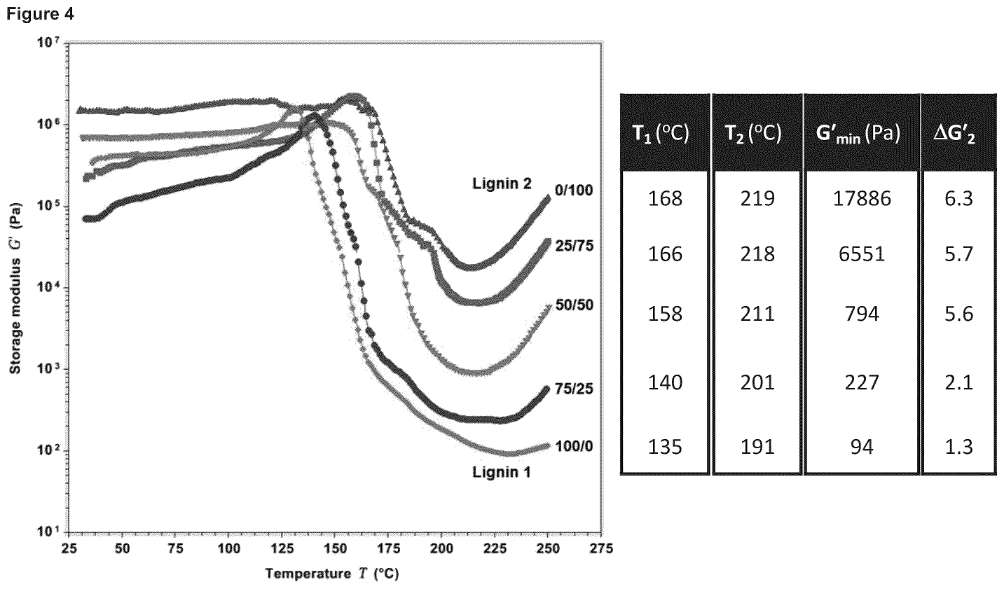

FIG. 4 shows the effect of blending two different lignin samples on the resulting blend viscoelastic metrics as measured under air using 25 mm lignin pellet. Lignin 1 is a lignin derivative derived from hardwood (North America) and produced by pulping of lignocellulosics by ethanol/solvent pulping (organosolv) and Lignin 2 is a lignin derivative derived from softwood (North America) and produced by pulping of lignocellulosics by Kraft pulping. The blend was prepared by combining discrete fractions of Lignin 1 and Lignin 2 after pulping. It can be seen that the dilution of Lignin 2 with increasing amounts of Lignin 1 has the effect of decreasing all of its viscoelastic metrics. Any decrease in softening temperature (T₁) is met with a corresponding decrease in extent of crosslinking, ΔG′₂. As can be seen from FIG. 4, a blend of at least 75% Lignin 1 and 25% Lignin 2 has a G′ₘᵢₙ of less than 10,000 Pa and an increase in storage modulus (ΔG′₂) from G′ₘᵢₙ to that measured at 250° C. (G′₂₅₀) that is less than 4. A sample of entirely Lignin 1 also has a G′ₘᵢₙ of less than 10,000 Pa and an increase in storage modulus (ΔG′₂) from G′ₘᵢₙ to that measured at 250° C. (G′₂₅₀) that is less than 4. Table 2 shows the Lignin samples from Examples 2 and 3 which have a G′ₘᵢₙ of less than or equal to 10,000 Pa and a ΔG′₂ less than about 4 or more than about 7.

TABLE 2
Lignin samples with a G′ₘᵢₙ of less than 10,000 Pa
and a ΔG′₂ less than about 4 or more than about 7

| Lignin | G′ₘᵢₙ | ΔG′₂ | Biomass and Pulping |
|---|---|---|---|
| Lignin 3 in Figure 3 | 3,100 Pa | 19.4 | Eucalyptus; Kraft |
| (middle curve) | | | |
| Lignin 1 in Figure 3 | 60 Pa | 3.6 | North America hardwood; |
| (bottom curve) | | | organosolv |
| Lignin 1 in Figure 4 | 94 Pa | 1.3 | North America hardwood; |
| | | | organosolv |
| 75% Lignin 1 and 25% | 227 Pa | 2.1 | 75% North America |
| Lignin 2 in Figure 4 | | | hardwood by organosolv |
| | | | pulping and 25% |
| | | | softwood by Kraft pulping |

### Example 4: Effect of Lignin Viscoelastic Metrics on Phenol-Formaldehyde Resin Shear Strength

Table 3 illustrates the effect of lignin viscoelastic metrics on resulting thermoset resin performance in a typical engineered wood product application. Lignin 1 and lignin 3 from Example 2 were used to replace 25% of a standard phenol-formaldehyde (PF) resin and the impact on shear strength was determined using an automated bond evaluation system (ABES). Approximately 1.8 g of resin was applied to a conditioned (25° C./50% RH) set of hardwood veneers and the bond strength determined after curing for 15 seconds at 190° C. It can be seen that lignin 3 with the higher potential for cross-linking (larger ΔG′₂) produced a bond strength superior to the lignin 1.

TABLE 2
Effect of lignin substitution for phenol-formaldehyde
resin on resulting lap shear bond strength

| | | | Shear |
|---|---|---|---|
| | T₂ | | Strength |
| Resin | (° C.) | ΔG′₂ | (MPa) |
| PF (100) | | | 5.3 |
| PF/lignin 1 (75/25) | 166 | 3.6 | 4.8 |
| PF/lignin 3 (75/25) | 232 | 19.4 | 5.6 |

### REFERENCES

Baker, D. A. and T. G. Rials (2013). “Recent advances in low-cost carbon fiber manufacture from lignin.” Journal of Applied Polymer Science 130 (2): 713-728.
Baker, D. A., F. S. Baker and N. C. Gallego (2009). Thermal Engineering of Lignin for Low-cost Production of Carbon Fiber. The Fiber Society 2009 Fall Conference. Athens Georgia.
Baker, D. A., N. C. Gallego and F. S. Baker (2012). “On the characterization and spinning of an organic-purified lignin toward the manufacture of low-cost carbon fiber.” Journal of Applied Polymer Science 124 (1): 227-234.
Hu, T. Q. (2002). Chemical Modification, Properties, and Usage of Lignin, Springer US.
Macfarlane, A. L., M. Mai and J. F. Kadla (2014). 20—Bio-based chemicals from biorefining: lignin conversion and utilisation. Advances in Biorefineries. K. Waldron, Woodhead Publishing: 659-692.
Mainka, H., O. Täger, E. Körner, L. Hilfert, S. Busse, F. T. Edelmann and A. S. Herrmann (2015). “Lignin—an alternative precursor for sustainable and cost-effective automotive carbon fiber.” Journal of Materials Research and Technology 4 (3): 283-296.
Norberg, I., Y. Nordstrom, R. Drougge, G. Gellerstedt and E. Sjoholm (2013). “A new method for stabilizing softwood kraft lignin fibers for carbon fiber production.” Journal of Applied Polymer Science 128 (6): 3824-3830.
Paul, D. R. and C. B. Bucknall (2000). Polymer Blends: Formulation, Wiley.

1. An anthropogenic lignin derivative having a minimum storage modulus (G′ₘᵢₙ) of less than or equal to 10,000 Pa, and an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is less than about 4 or more than about 7,
wherein the lignin derivative is derived from hardwood biomass or from a combination of hardwood biomass and softwood biomass with at least 75% hardwood biomass, and is produced by pulping of lignocellulosics by Kraft pulping or ethanol/solvent pulping.

2. The anthropogenic lignin derivative of claim 1, characterized as having a G′ₘᵢₙ of about 8,000 Pa or less, about 5,000 Pa or less, or about 1,000 Pa or less, or about 100 Pa or less.

3. The anthropogenic lignin derivative of claim 1, wherein the lignin derivative has an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is about 7 or greater, about 8 or greater, or about 10 or greater.

4. The anthropogenic lignin derivative of claim 1, wherein the lignin derivative has an extent of crosslinking (ΔG′₂=G′₂₅₀/G′ₘᵢₙ) such that an increase in storage modulus (ΔG′₂) from G′ₘᵢₙ to that measured at 250° C. (G′₂₅₀) is about 3 or less.

5. The anthropogenic lignin derivative of claim 1, wherein the lignin derivative has an onset of softening temperature (T₁) greater than or equal to 110° C.

6. The anthropogenic lignin derivative of claim 1, wherein the lignin derivative has a cross-over temperature (T₂) from predominantly viscous to predominantly elastic behaviour of greater than or equal to 165° C.

7. The anthropogenic lignin derivative of claim 3, wherein the lignin derivative is derived from hardwood biomass.

8. The anthropogenic lignin derivative of claim 7, wherein the lignin derivative is produced by pulping of lignocellulosics by Kraft pulping.

9. An anthropogenic lignin derivative prepared for use in forming fibres, films, sheets, coatings, particles and nanoparticles, wherein said lignin derivative is characterized as having a minimum storage modulus (G′ₘᵢₙ) of greater than or equal to 100,000 Pa, and a tan(δ) of less than 1.

10. The anthropogenic lignin derivative of claim 9, wherein the lignin derivative has a G′ₘᵢₙ of about 200,000 Pa or greater.

11. The anthropogenic lignin derivative of claim 9, wherein the lignin derivative is derived from hardwood biomass.

12. The anthropogenic lignin derivative of claim 11, wherein the lignin derivative is produced by pulping of lignocellulosics by Kraft pulping.

13. The anthropogenic lignin derivative of claim 12, wherein the lignin derivative is subject to a thermal treatment at a temperature greater than 150° C. after pulping.

14. The anthropogenic lignin derivative of claim 9, wherein the lignin derivative is produced by pulping of lignocellulosics by Kraft pulping.
